(19) United States
(12) Patent Application Publication
(10) Pub. No.: US 2010/0084872 A1
(43) Pub. Date: Apr. 8, 2010

(54) SPEED INCREASER

(75) Inventor: Michael E. WINIASZ, Lorain, OH (US)

Correspondence Address: FAY SHARPE LLP, 1228 Euclid Avenue, 5th Floor, The Halle Building, Cleveland, OH, 44115, US

(73) Assignee: ADI WIND, LLC

(21) Appl. No.: 12/572,672

(22) Filed: Oct. 2, 2009

Related U.S. Application Data
(60) Provisional application No. 61/103,424, filed on Oct. 7, 2008.

(51) Int. Cl. F03D 9/00; F16H 1/32; F16H 57/04

(52) U.S. Cl. 290/55; 475/162; 475/180; 475/159

(57) ABSTRACT

A speed increaser is disclosed that translates slow rotating, high torque motion to high rotation, low torque motion and is suitable for use in a device like a wind turbine. The speed increaser has certain advantages, such as reduced weight and/or size compared to other units having the same performance characteristics. The speed increaser employs an externally toothed spur gear orbiting in a non-rotating manner inside an internally toothed ring gear. The input drives the ring gear and the orbiting spur gear drives an eccentric on the output shaft. In one embodiment, cross guide projections on the spur gear and cross guide projections on the housing engage slots in a swash plate. In another embodiment, cross guide projections on one side of a swash plate engage slots in the housing and cross guide projections on the opposite side of the swash plate engage slots in the orbiting spur gear; and, hardened wear plates and lubricant passages are provided on the swash plate cross guide projections. In another embodiment, the speed increaser housing includes an electric generator with the rotor driven by the speed reducer output shaft. In another version, the speed increaser and generator are housed within the hub of a fluid turbine impeller. In another version of the speed reducer, multiple output shafts are driven by the orbiting spur gear.

This application claims the benefit of U.S. Provisional Application Ser. No. 61/103,424, filed Oct. 7, 2008, entitled SPEED REDUCER, by Michael E. WINIASZ, the disclosure of which is incorporated herein by reference in its entirety.

### BACKGROUND

The present disclosure relates to a speed increaser that is suitable for use on motors and/or turbines, such as a wind turbine, for converting slow rotating, high torque motion into high rotation, low torque motion. The present disclosure can also be described as a planocentric gearbox.

Presently, gear boxes for wind turbine applications are complex multi-stage gearing arrangements which are not only bulky and heavy but quite difficult to service when installed on the wind turbine tower. For example, a presently available 600 kilowatt commercially available wind turbine gear box weighs about 8,600 pounds or approximately 77 watts per pound.

It has thus been desired to provide a way or means of reducing the complexity, size and weight of a gear box for substantially increasing the speed of an input shaft and particularly for wind turbine generator applications.

### BRIEF DESCRIPTION

Disclosed in embodiments are gearboxes that provide large increases in shaft rotational speed in an efficient manner. A gearing arrangement is provided in a housing and is capable of being mounted to a source of input power, such as a motor, turbine, or other prime mover. Such speed increasers are useful for enabling large increases in shaft rotational speed in a small volume of space, which can be useful in machines such as wind turbines.

In some embodiments, the speed increaser comprises a housing, an input shaft, an internal spur gear, an external spur gear, a top plate, a cross plate, an eccentric ring, and an output shaft. The housing has a first end and a second end. The rotatable input shaft extends through the first end and including a plate mounted on one end. The internal spur gear is mounted on the plate. An external spur gear engages the internal spur gear and has a first pair of cross guide pins projecting therefrom towards the second end of the housing. The top plate is located at the second end of the housing and has a second pair of cross guide pins projecting therefrom towards the first end of the housing. The cross plate is located between the top plate and the external spur gear and has a first pair of slots adapted to receive the first pair of cross guide pins and a second pair of slots adapted to receive the second pair of cross guide pins, both pairs of pins being movable within the slots. The eccentric ring is mounted along the rotational axis of the external spur gear. The rotatable output shaft extends through the top plate and the cross plate, and engages the eccentric ring.

In other embodiments, the speed increaser comprises a geared bearing, an inner gear, an output shaft, a swash plate, and a back plate. The geared bearing contains teeth on an internal face and can be attached to a hub plate. The inner gear contains teeth on an external face and is positioned to contact the teeth of the geared bearing. The inner gear has a bore and a first pair of drive dogs attached to a front face. The output shaft is positioned within the inner gear bore and is coaxial with the geared bearing. The swash plate contains a first pair of slots and a second pair of slots. The back plate has a second pair of drive dogs attached to a rear face. The first pair of drive dogs mates with the first pair of slots and the second pair of drive dogs mates with the second pair of slots.

In another embodiment or version of the disclosure, a speed increaser has an input member or shaft attached to an internally toothed ring gear which is journalled for rotation on a housing having an output shaft journalled for rotation thereon. The output shaft has an eccentric upon which is journalled an externally toothed spur gear having the pitch diameter of the teeth slightly less than the pitch diameter of the ring gear teeth with the spur gear contacting the teeth of the ring gear in orbiting non-rotating contact. The housing has a first pair of slots formed therein; and, the spur gear has a second pair of slots formed therein. A swash plate has a first pair of cross guide projections in the form of dogs or lugs on one side thereof and a second pair of cross guide projections in the form of dogs or lugs on the opposite or face thereof with the first set of dogs engaging the first set of slots in the housing and the second set of dogs engaging the second set of slots in the spur gear.

In yet another embodiment or version, the swash plate has hardened removable plates provided on the first and second set of dogs and on the surface of the swash plate for providing ready replacement of the sliding surfaces.

In another version or embodiment, the swash plate dogs are cross drilled for communicating with grooves in wear plates mounted on the dogs for providing lubricant galleries to feed lubricant to recesses formed in the wear plates. A lubricant supply port provided in the housing communicates with cross ports for supplying lubricant to the wear plates.

In another version or embodiment, the speed increaser has a generator stator and rotor mounted within the speed increaser housing with the stator mounted on the housing and generator rotor attached to the output shaft and thus the generator is positioned within the housing for the speed increaser. In another version, the input shaft or member has the hub of a fluid turbine impeller attached thereto and the hub extends over the housing of the speed increaser and generator forming an integral assembly.

In another version, the output shaft extends to have an end journalled within the impeller hub; and, the shaft may be a hollow tubular member for permitting power leads to pass through the shaft to the impeller hub for installations where the impeller hub is of the type containing servo motors for varying the pitch of the impeller blades.

In another version of the speed increaser, multiple output shafts are operated by a common orbiting spur gear and are disposed about the face of the housing.

The speed increaser of the present disclosure thus provides a mechanism for driving a generator such as employed in a wind turbine generator which is relatively small, lightweight and having simplified construction.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 is a side view of a first exemplary embodiment of a speed increaser of the present disclosure.

FIG. 2 is an exploded perspective view of the first exemplary embodiment a speed increaser of the present disclosure.

FIG. 3 is a series of different views of a second exemplary embodiment of a speed increaser of the present disclosure.

FIG. 4 is an exploded perspective view of the second exemplary embodiment of a speed increaser of the present disclosure.

FIG. 5a is an end view of another version of the speed increaser of the present disclosure.

FIG. 5b is a cross section of the speed increaser of FIG. 5a.

FIG. 6 is an exploded view of the speed increaser of FIG. 5.

FIG. 7 is an exploded view of the swash plate of the speed increaser of FIG. 5.

FIG. 8 is a phantom pictorial view of the swash plate of FIG. 7 illustrating the lubricant passages.

FIG. 9 is a side view of the version of FIG. 5 illustrating the lubricant supply and vent ports.

FIG. 10 is a view from the end of the output shaft of the speed increaser of FIG. 9.

FIG. 11 is a cross-section of the speed increaser of FIG. 5 assembled with an electric generator.

FIG. 12 is a view of the version of FIG. 11 incorporated in the hub of a fluid turbine with portions of the housing broken away and mounted on a support.

FIG. 13 is a cross-section of the impeller hub speed increaser and generator of FIG. 12.

FIG. 14 is an enlarged cross-section of the impeller hub speed increaser and generator of FIG. 13.

FIG. 15 is a perspective view of a version of the speed increaser of the present disclosure having multiple output shafts.

FIG. 16 is a cross-section taken along the section indicating lines 16-16 of FIG. 15.

FIG. 17 is a section view taken along section indicating lines 17-17 of FIG. 16.

### DETAILED DESCRIPTION

A more complete understanding of the components, processes and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

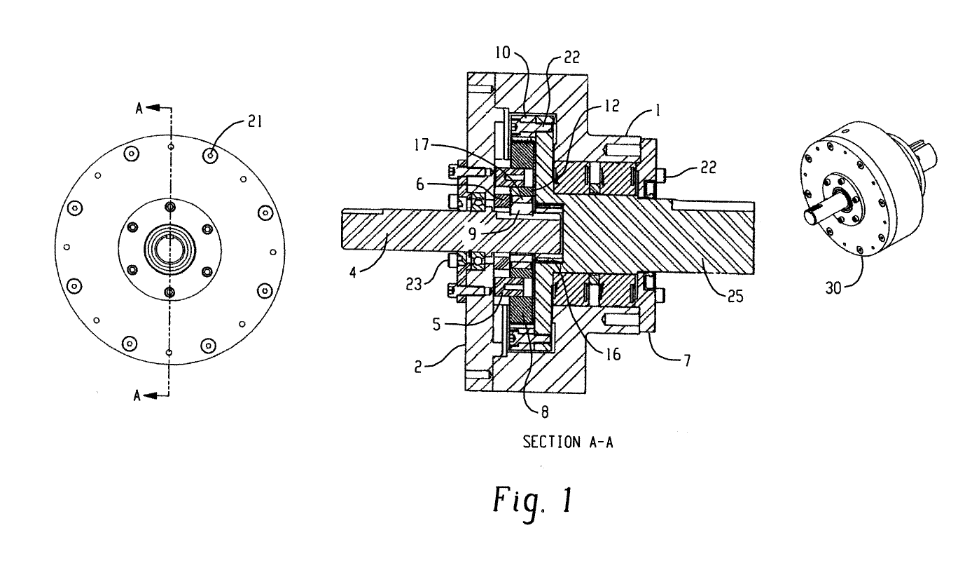

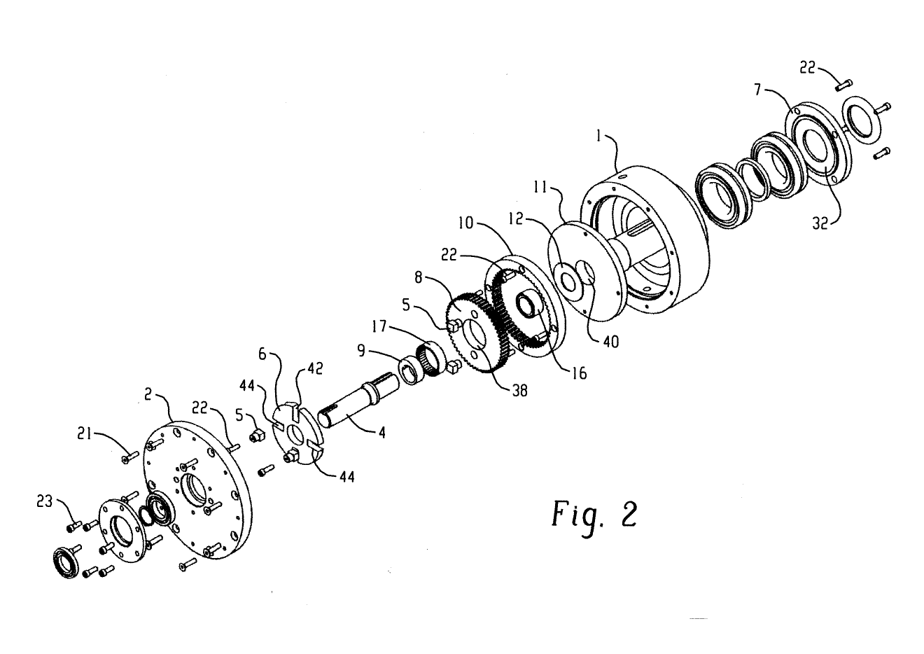

Shown in FIGS. 1 and 2 is an exemplary embodiment of a speed increaser of the present disclosure. The speed increaser's input source and prime mover, such as an electric motor, a hydraulic motor, or a wind turbine is capable of being mounted to a hub plate 11. The hub plate may be attached to an input shaft 25, as seen in FIG. 1, if desired. The gearing arrangement is contained in a housing assembly 30 comprising a housing member or gearbox housing 1. The input shaft 25 enters the housing member 1 through a central opening 32 in a seal plate 7. The output shaft 4 enters the housing member 1 through a central opening 34 in a top plate 2. The seal plate and top plate are attached to the housing member 1 by fasteners such as screws 21, 22, 23.

An internal spur gear 10 is mounted to the hub plate 11. As the hub plate 11 rotates, the internal spur gear 10 is rotated.

An external spur gear 8 engages the internal spur gear 10. One or more bearings 12, 16 may be inserted to separate the external spur gear 8 from the hub plate 11. The external spur gear may include a bore 38 in its center (i.e. along the rotational axis). As shown here, a bearing 17 is located within this portion. An eccentric ring 9 is located within the bearing 17 and an output shaft 4 engages the eccentric ring 9. In some embodiments, the output shaft 4 extends into a bore 40 located in the center of the hub plate 11.

The external spur gear 8 moves in an orbiting, non-rotating manner with respect to the rotation of the internal spur gear 10. Put another way, the external spur gear 8 is sized so that it fits inside the internal spur gear 10, but is not so large that it meshes completely with the internal spur gear. The center of the internal spur gear is offset from the center of the external spur gear by a distance known as the offset diameter. The eccentric ring 9 is shaped so that the output shaft 4 is coaxial with the hub plate 11.

The non-rotation of the external spur gear 8 is enforced through connection to a cross plate 6. The cross plate 6 is located generally between the top plate 2 and the external spur gear 8. Two cross guide pins 5 are mounted in the external spur gear. As shown here, the two cross guide pins are equally spaced from the geometric center of the external spur gear and are located on opposite sides of a line, so that the two cross guide pins are located 180° apart from each other. The pins extend from the external spur gear 8 into a first pair of elongated slots 42 in the cross plate 6. The portion of the cross guide pins 5 connected to the external spur gear 8 are round in cross-section, while the portion of the cross guide pins 5 extending into the slots of the cross plate 6 are square in cross-section. The slots confine the pins and allow motion of the external spur gear 8 along only one axis.

Similarly, two cross guide pins are mounted in the top plate 2. These pins extend from the top plate 2 into a second pair of elongated slots 44 in the cross plate. The portion of the cross guide pins 5 connected to the top plate 2 are round in cross-section, while the portion of the cross guide pins 5 extending into the slots of the cross plate 6 are square in cross-section. Again, the slots confine the pins and allow motion of the cross plate along only one axis. The first pair 42 and second pair 44 of elongated slots are perpendicular to each other. The combination of the pins extending from the top plate 2 to the cross plate 6, and the pins extending from the cross plate 6 to the external spur gear 8, prevent the external spur gear from rotating, but still allow orbital motion.

As the internal spur gear 10 rotates, its teeth engage corresponding teeth on the external spur gear 8. The external spur gear has fewer teeth than the internal spur gear. As a result, the center axis of the non-rotating external spur gear orbits faster than the internal spur gear. Due to this orbital motion of the external spur gear 8, the eccentric ring 9 rotates, causing the output shaft 4 to rotate as well. Again, the output shaft 4 is co-axial with the hub plate 11 due to the combination of eccentricities in the external spur gear 8 and the eccentric ring 9.

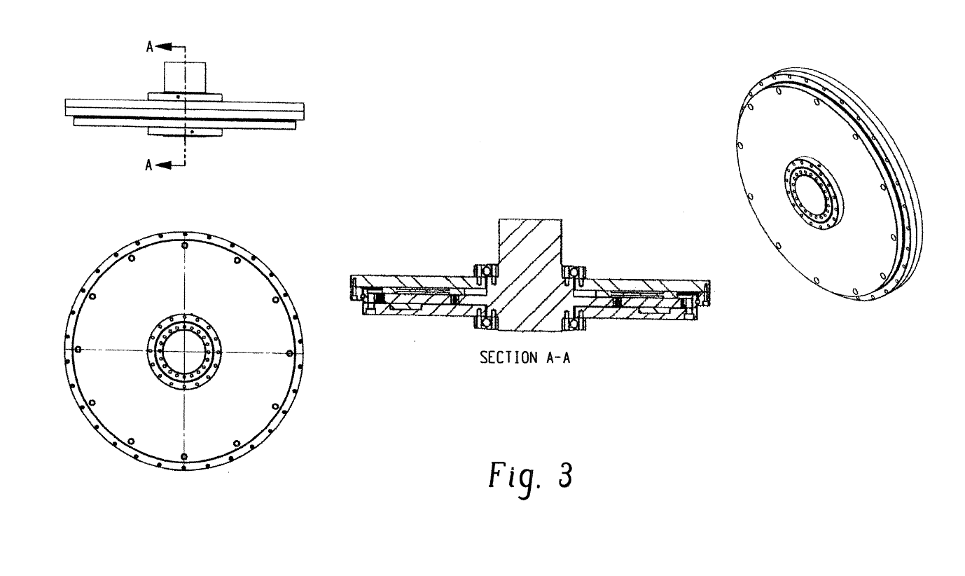

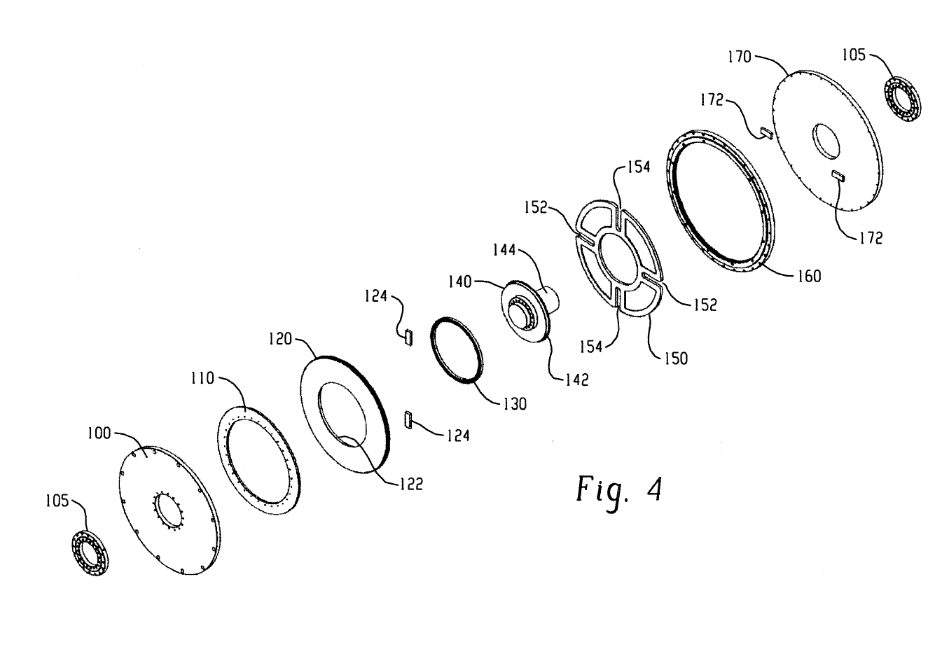

Shown in FIGS. 3 and 4 are perspective views of another exemplary embodiment of the speed increaser. The gearing components are arranged between a hub plate 100 and a back plate 170. The hub plate 100 supports a geared bearing 160. The hub plate 100 also transmits an input rotational load to the geared bearing 160. The geared bearing 160 has teeth on its inside face.

An inner gear 120 has teeth located on its outside face. The inner gear 120 has fewer teeth than the geared bearing 160. The inner gear is positioned inside, but not concentric with, the geared bearing 160 such that their gear teeth engage. The inner gear 120 moves in an orbiting, non-rotating manner with respect to the rotation of the geared bearing 160. The inner gear 120 contains a bore 122 and has a bore axis which is offset from the bore axis of the geared bearing 160 for a distance known as the offset diameter.

A bearing 130 is located within the bore 122. Located within the bearing 130 is an output assembly 140. The output assembly 140 comprises a ring 142 and an output shaft 144. The ring 142 also contains an offset diameter, such that the output shaft 144 and the hub plate 100 are co-axial. The bearing 130 provides a rotational slipping motion between the output shaft 144 and the bore 122 of the inner gear 120.

The ends of the output shaft 144 extend through bores in both the hub plate 100 and the back plate 170. The two ends are supported by two (2) sets of bearings 105.

The inner gear 120 is separated from the hub plate 100 by the thrust ring 110, which is bolted to the hub plate 1. The geared bearing 160 is also bolted or affixed to the hub plate 100, such that the thrust ring is within the geared bearing 160. The thrust ring 110 has a slightly smaller diameter than the inner gear 120, to ensure that the thrust ring does not contact the teeth of the inner gear as the inner gear orbits.

A swash plate 150 separates the inner gear 120 from the back plate 170 and fits within the diameter of the geared bearing 160. The swash plate 150 also prevents the inner gear 120 from rotating. The swash plate 150 is slotted on four quadrants to fit over the drive dogs. The drive dogs are square keys which mate with the slots on the swash plate 150. Two (2) of the drive dogs 172 are located on the back plate 170 and mate with slots 152. The other two (2) drive dogs 124 are located on the inner gear 120 and are rotated 90 degrees in orientation from the two (2) drive dogs 172 located on the back plate 170. Although the drive dogs 124, 172 are shown here as separate components, in this embodiment they may be made as integral parts of the inner gear 120 and back plate 170, respectively. The drive dogs 124 mate with slots 154 on the swash plate 150. This arrangement prevents the inner gear 120 from rotating, but allows the inner gear 120 to orbit.

The geared bearing 160 has a height such that the thrust ring 110, inner gear 120, and swash plate 150 are all contained within it. Put another way, when assembled and seen from the exterior, the hub plate 100, geared bearing 160, and back plate 170 may be visible, but the thrust ring 110, inner gear 120, and swash plate 150 need not be seen.

When a power source applies rotational force to the hub plate 100, the hub plate's bolted connection with the geared bearing 160 causes the geared bearing to rotate with the same rotational force and at the same rotational speed. Because the teeth of the inner gear 120 are engaged with the teeth of the geared bearing 160, the rotational forces on the geared bearing are transferred through the inner gear 120 to the drive dogs and the swash plate 150. Because the drive dogs and swash plate will not allow the inner gear 120 to rotate, the rotational forces in the geared bearing 160 act as a tooth separating force, pushing the inner gear in an orbiting motion around the output shaft 144. The orbiting motion and transferred force causes the output shaft 144 to rotate.

The resulting speed increaser has a gear ratio calculated by the number of teeth in the geared bearing 8, divided by the difference in number of teeth between the geared bearing 8, and the inner gear 2. The gear ratio may be from about 50:1 to about 60:1 (output:input).

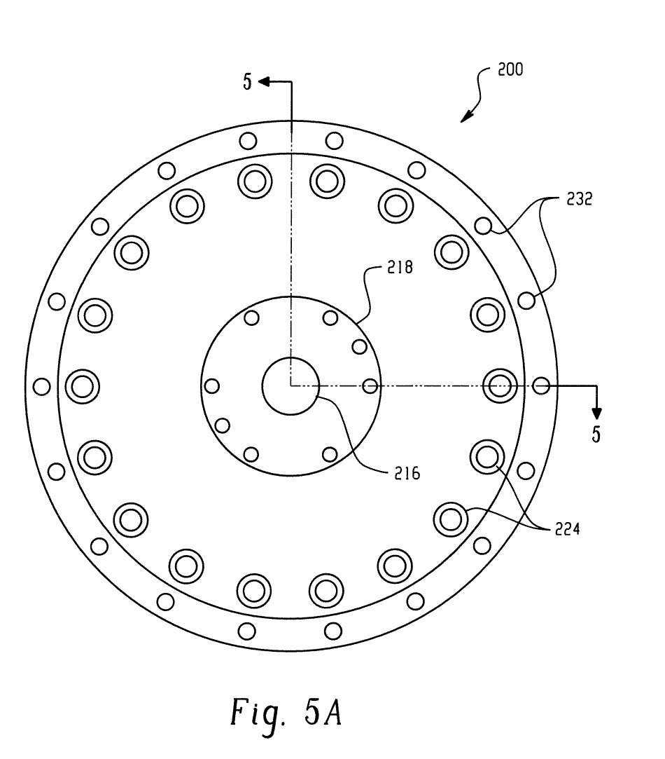

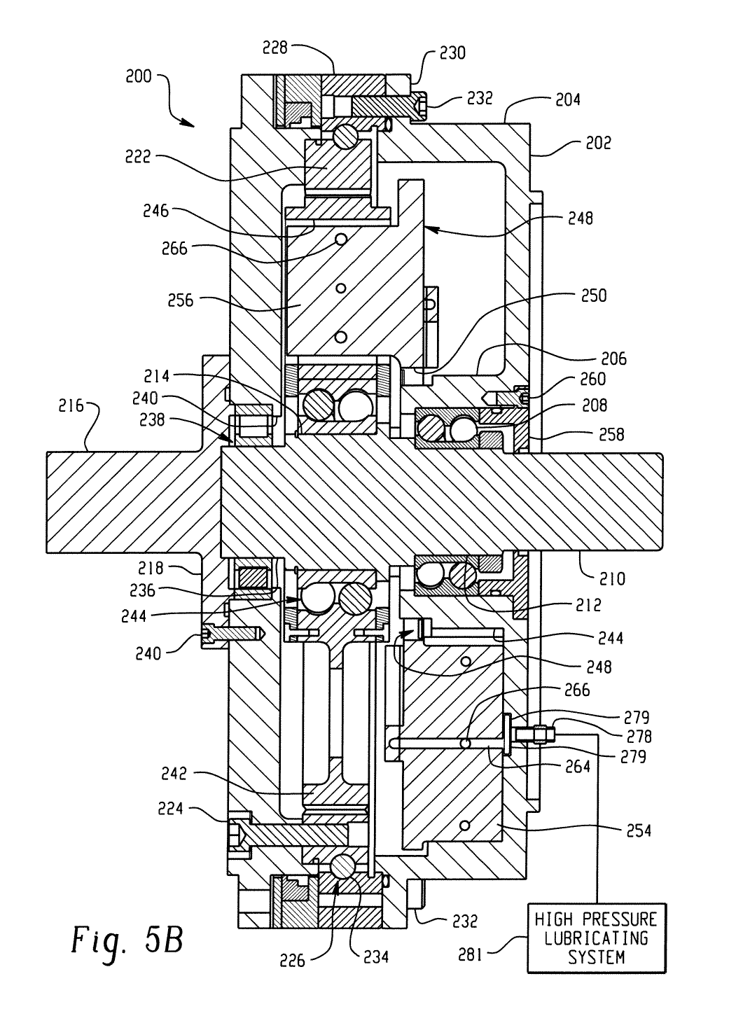

Referring to FIGS. 5a, 5b and 6, another embodiment or version of the present disclosure is indicated generally at 200 and includes a housing 202 having a generally cylindrical wall portion 204 forming the outer periphery thereof and having an inner hub 206 which has a bearing assembly therein indicated generally at 208 which has journalled therein an output shaft 210. The shaft 210 has a raised diameter portion 212 which is received in close fitting engagement with the inner race of the bearing 208. Shaft 210 has axially spaced from diameter 212 an eccentric diameter 214 the amount of offset thereof which will be hereinafter described.

The speed increaser 200 has an input shaft 216 with a flanged hub 218 which is attached to a generally circular plate 220 extending radially outwardly therefrom which plate is attached adjacent its outer periphery to an internally toothed ring gear 222 by a plurality of circumferentially spaced fasteners such as cap screws 224. The ring gear is journalled on its outer periphery in a bearing indicated generally at 226 which bearing has the outer race thereof denoted by reference numeral 228 secured to a flange 230 formed on housing 202 by a plurality of fasteners such as cap screws 232. Bearing assembly 226 preferably includes a plurality of ball races denoted by reference numeral 234 but may alternatively comprise a plain bearing.

Shaft 210 has a diameter 236 formed on the end thereof which diameter is journalled by a bearing assembly indicated generally at 238 in a central bore 240 provided in the plate 220.

Thus, in operation, power inputted to shaft 216 causes plate 220 to rotate ring gear 222 in bearing assembly 226.

An externally toothed spur gear 242 is disposed within ring gear 222; and, the gear 242 has a bearing assembly indicated generally at 244 provided on the hub of gear 242 which bearing assembly has its inner race assembled in closely fitting engagement over the eccentric diameter 214 provided on the output shaft 210. The spur gear 242 has a pitch diameter of its teeth slightly less than the pitch diameter of the internal teeth on ring gear 222. It will be understood that the offset or eccentricity of the diameter 214 is equal to the difference in the pitch diameter of the ring gear teeth and the pitch diameter of the spur gear teeth.

Housing 202 has a pair of elongated cross guide slots 244 formed therein extending disposed in diametrically opposed radially extending orientation, one of which pair 244 is shown in FIGS. 5b and 6.

Spur gear 242 has a similar pair of diametrically opposed radially extending cross guide slots 246 formed therethrough, one of which is shown in FIG. 5b and both of which are shown in FIG. 6. A swash plate indicated generally at 248 has a clearance hole 250 formed centrally therein for clearing the hub 206 of the housing; and, the swash plate has a pair of diametrically opposed radially extending cross guide projections in the form of dogs or lugs 254 provided on the end of distal face thereof in FIG. 6 or right-hand face thereof in FIG. 5b with one of the pair of dogs 254 shown in FIGS. 5b and 6. The axially opposite face of the swash plate 248 or left-hand face in FIG. 5b and proximal face in FIG. 6 has a second pair of cross guide projections in the form of dogs or lugs 256 formed thereon in diametrically opposed relationship with both of the second pair of dogs 256 illustrated in FIG. 6. The pair of cross guide projections or dogs 254 slidingly engages the slots 244 in housing 202; and, the second pair of cross guide projections or dogs 256 slidingly engages the slots 246 in the spur gear 242. It will be understood that the pair of dogs 254 are diametrically arranged at 90° to the orientation of the dogs 256 to permit orbital movement of the spur gear 242.

Bearing assembly 208 is retained in the housing hub 206 by a collar 258 secured to the housing by cap screws 260.

In the present practice, it has been found satisfactory to form the swash plate and dogs integrally of titanium or aluminum material. The slots formed in the housing may have wear resisting inserts on the sliding surfaces thereof and formed of material with a pressure-velocity rating

$$PV = \frac{Applied Force ( N )}{Projected bearing area ( m 2 )} \times linear velocity ( m \text{/} sec )$$

of 275,000. In the present practice, it has been found satisfactory to use a bronze alloy commercially available and sold under the designation “ToughMet® 3 AT110 Temper Plate” and obtained from the Brush-Wellman Company, Toledo, Ohio. In the present practice, the output shaft has been satisfactorily formed of titanium material; however, other suitable materials may be used. The orbital gear has been satisfactorily formed of SAE 1050 carbon steel hardened to about 20 to 24 on the Rockwell “C” scale; however, other suitable gear materials may be employed. The slots in the spur gear also may have bronze alloy insert plates (not shown) for providing wear resistance thereto.

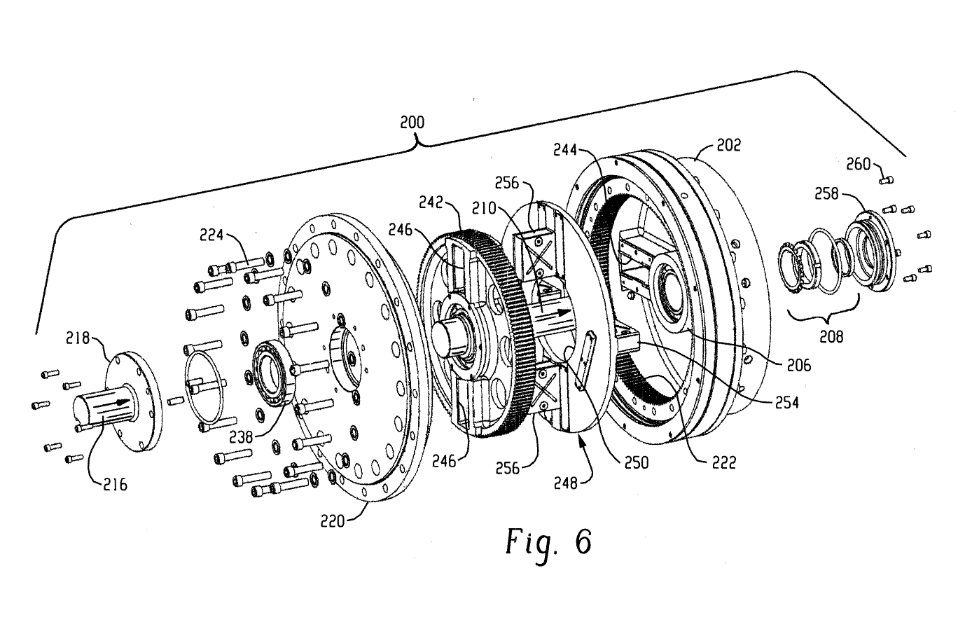

Referring to FIG. 7, the swash plate 248 has the dogs 254 and 256 provided with hardened face plates denoted 258 for dogs 254 and 259 for dogs 256. The face plates may be retained on the dogs by threaded fasteners such as countersunk screws 262. In the present practice, it has been satisfactory to form the face plates on the dogs of AISI type 440 stainless steel hardened to a range of about 50-55 on the Rockwell “C” scale. However, other suitable hardened materials may be used. If desired, additional wear plates 257 may be mounted on the faces of the swash plate adjacent the dogs 254, 256.

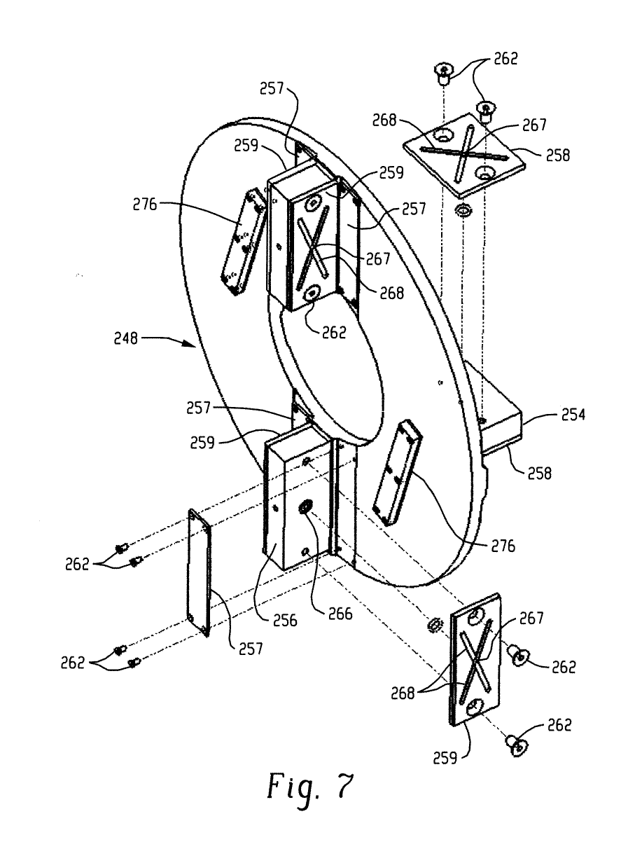

Referring to FIGS. 7 and 8, the swash plate dogs 254, 256 are shown as having a plurality of cross-bores shown shaded in FIG. 8 and denoted by reference numerals 254, 266 which are connected to opposite sides of the lugs and which intersect grooves 268 formed on the outer surface of the plates attached to the sides of the dogs. The cross-bores intersect grooves such as 270, 272 formed in external plates 274, 276 provided on the faces of the swash plate to provide continuous passages for lubricants. The cross-bores such as 264, 266 communicate with holes 267 in the wear plates (See FIG. 7) and feed lubricant to the plate grooves 268.

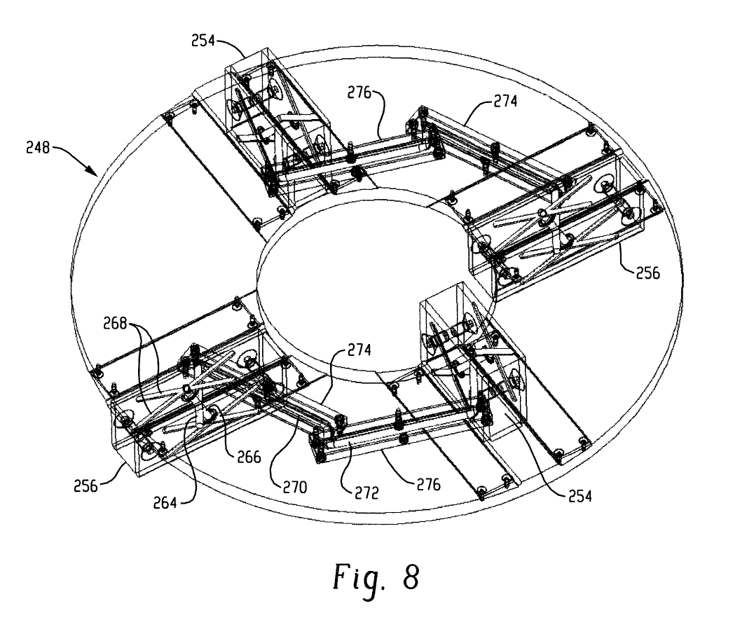

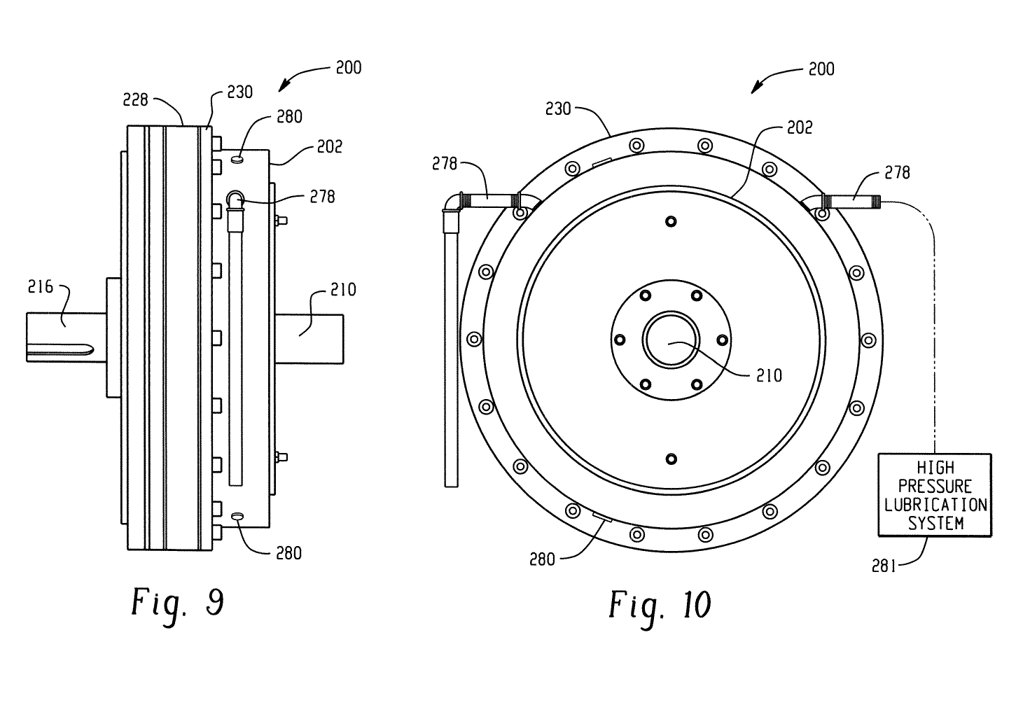

Referring to FIGS. 5b, 9 and 10, inlet ports 277 are provided in the housing and have supply fittings 278 attached thereto connected to a relatively high pressure lubricating system 281 adequate to provide a film of lubricant between the sliding cross guide projections and the slots in the ring gear and housing. The housing also has vent ports 280 provided therein. A lubricant face seal 279 is provided between the housing and the sliding dogs 254.

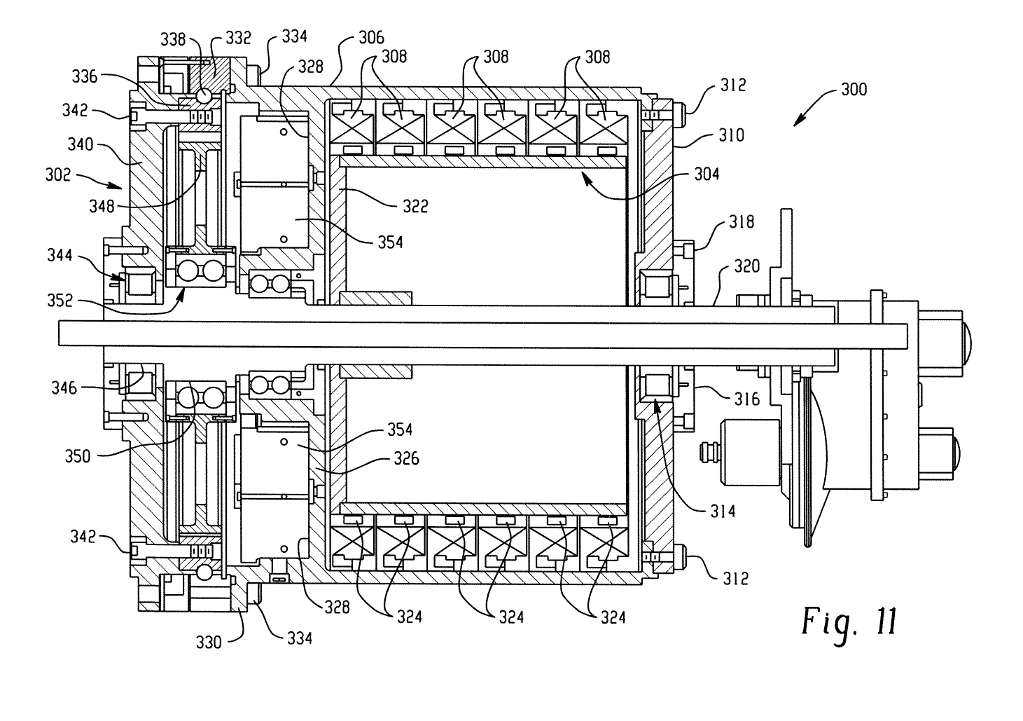

Referring to FIG. 11, another embodiment of the speed increaser of the present disclosure is indicated generally at 300 and comprises the speed increaser indicated generally at 302 integrated with an electrical generator indicated generally at 304 assembled in a common housing 306 which has a plurality of generator stator windings 308 disposed on the interior thereof. The housing has an end wall portion 310 which may comprise a separate plate attached thereto by fasteners such as cap screw 312 and which has a central bearing assembly indicated generally at 314 and which is retained by a retaining collar or plate 316 secured to the end plate 310 by suitable fasteners 318.

Bearing 314 has one end of the hollow output shaft 320 journalled therein. The output shaft 320 has a rotor 322 mounted thereon for rotation therewith and which rotor includes generator magnets 324 disposed for, upon rotation of shaft 320, generating current in the stator windings 308. The output shaft 320 extends continuously through the speed increaser 302 and has the opposite end thereof journalled therein as will hereinafter be described.

Housing 306 has a radially inwardly extending flange portion 326 which has formed therein a pair of diametrically opposed radially extending cross guide slots 328. Housing 306 also has a radially outwardly extending flange 330 onto which is secured an outer bearing race ring 332 by suitable fasteners, such as circumferentially spaced cap screws 334. The outer bearing race 332 has journalled therein the outer periphery of an internally toothed ring gear 336 for rotation on bearings 338 with respect to the outer race 332. The ring gear has securely attached thereto for rotation therewith an input member or hub plate 340 and retained thereon by suitable fasteners such as cap screws 342. The input member 340 has a centrally disposed bearing assembly indicated generally at 344 and into which is journalled the opposite end of output shaft 320 on the reduced diameter portion 346 thereof. It will be understood that the input member is connected to a source of rotary power such as the impeller of a fluid turbine or a hydraulically operated motor.

An externally toothed orbital spur gear 348 is disposed within the ring gear 336 and is journalled about an eccentric diameter 350 on the output shaft by a suitable bearing assembly indicated generally at 352. The spur gear has a pair of diametrically opposite radially extending cross guide slots (not shown in FIG. 11) into which are received a pair of cross guide dogs (not shown in FIG. 11) extending from an axial face of a swash plate (not shown) having a pair of cross guide dogs 354 extending into the slots 328 in the housing in a manner similar to the arrangement of the speed increaser of FIG. 5. The construction of the ring gear and spur gear is similar to that of the version of the speed increaser shown in FIG. 5. Rotation of the input member 340 causes rotation of the ring gear 336 which effects non-rotating orbiting of the spur gear 348 and driving of output shaft 320.

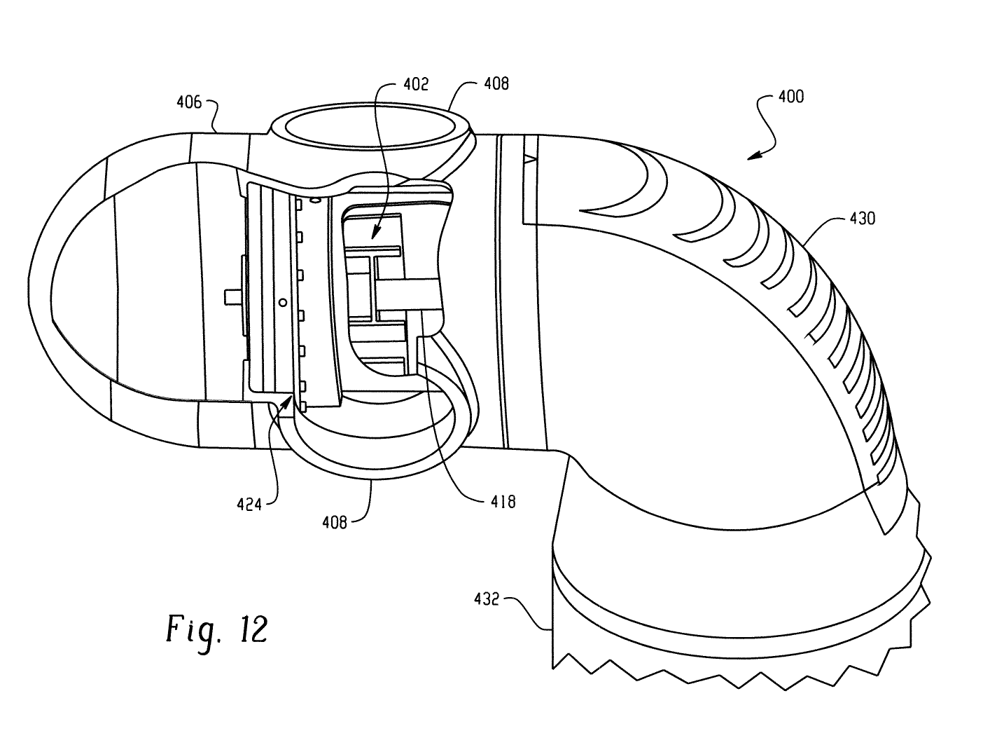

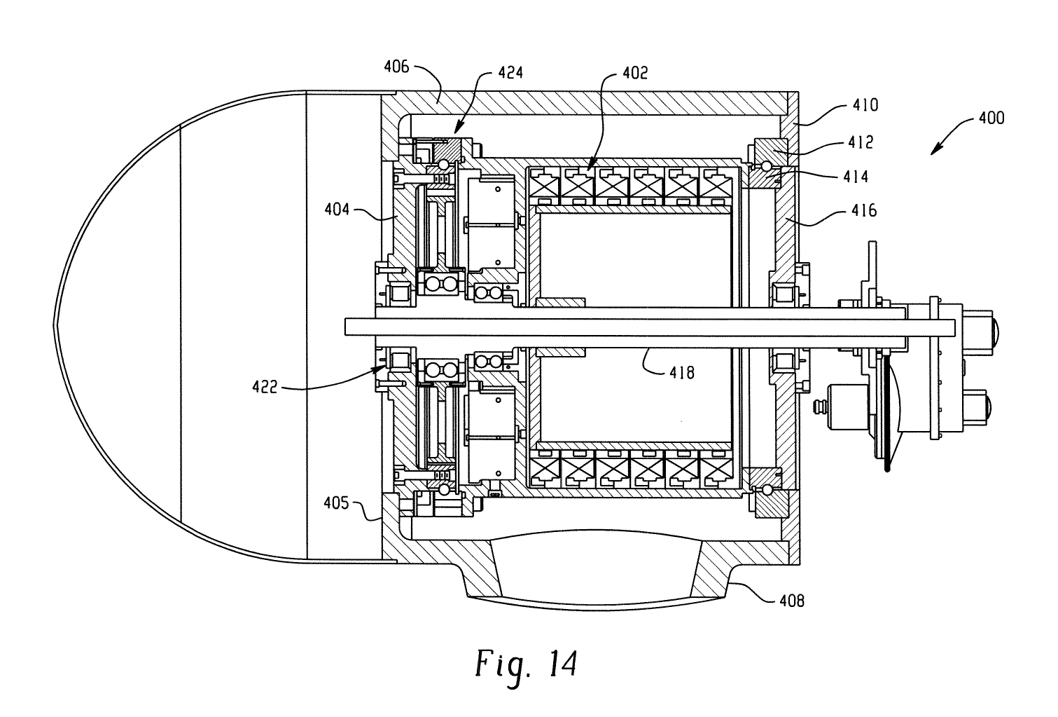

Referring to FIGS. 12, 13 and 14, another version of a combination speed increaser and generator is indicated generally at 400 and includes a generator assembly indicated generally at 402 which has the input member 404 thereof attached on inward flange 405 of to the hub 406 of a fluid turbine impeller which has apertured attachment bosses such as boss 408 formed thereon for securing fluid turbine blades (not shown) thereon. The hub 406 is received over the generator 402 and attached to an end ring 410 which has an outer bearing race 412 secured thereto which is journalled on an inner bearing race 414 attached to an end plate 416 of the housing for the generator 402.

The output shaft 418 has one end journalled in the end plate 416 by a bearing assembly 420; and, the opposite end of shaft 418 is journalled by bearing assembly indicated generally at 422 for rotation with respect to the impeller of 406. It will be understood that the construction and operation of the speed increaser indicated generally at 424 is otherwise similar to that of the versions of FIG. 11. The embodiment or version 400 thus permits the speed reducer and generator to be housed completely within the impeller hub of a fluid turbine.

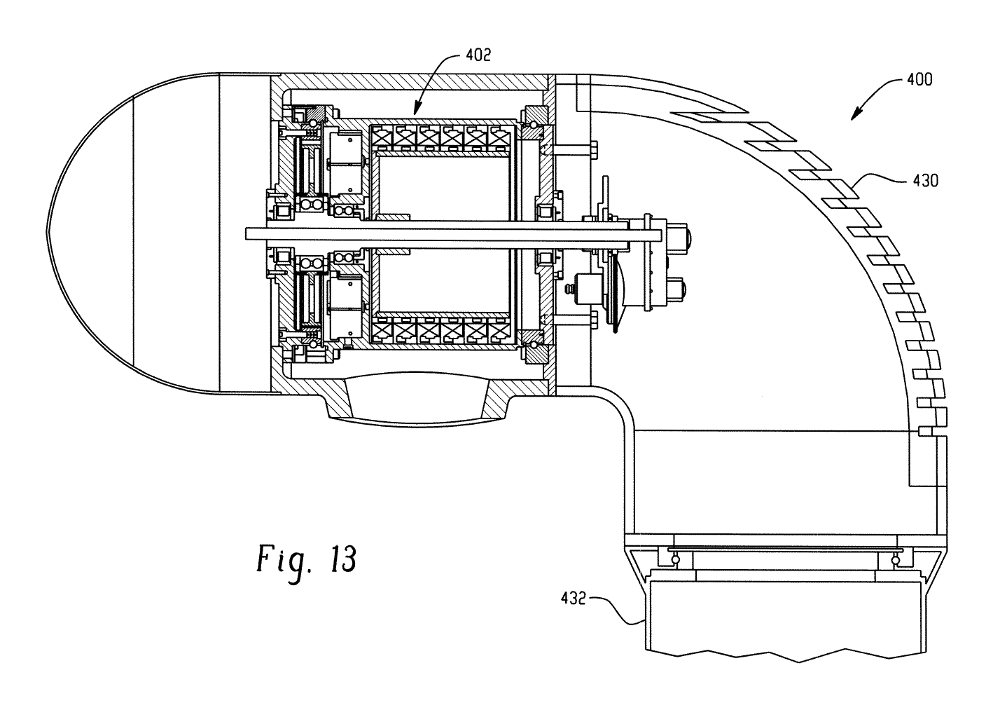

As shown in FIG. 13, the version 400 may be attached to a support housing such as housing 430 which may be rotatably mounted on a tower 432. In the arrangement of the version 400, it will be understood that the impeller hub may contain servo-motors (not shown) for changing the pitch of the un-shown blades; and, therefore, the hollow tubular output shaft 418, which extends the full length of the generator and speed increaser, permits power leads to be supplied through the hollow output shaft.

Thus, the speed increaser of the present disclosure is compact, and quite lightweight for a given power handling capacity.

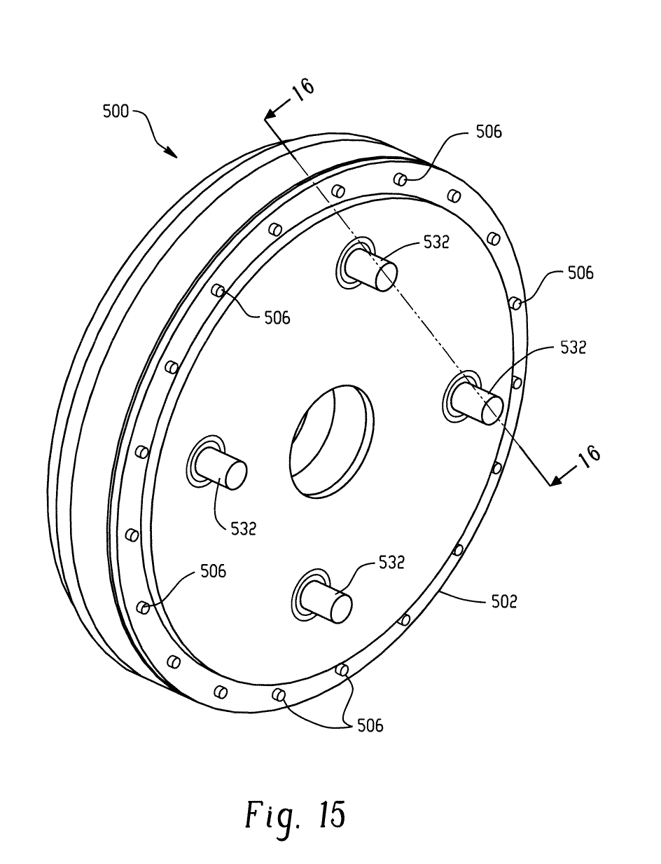

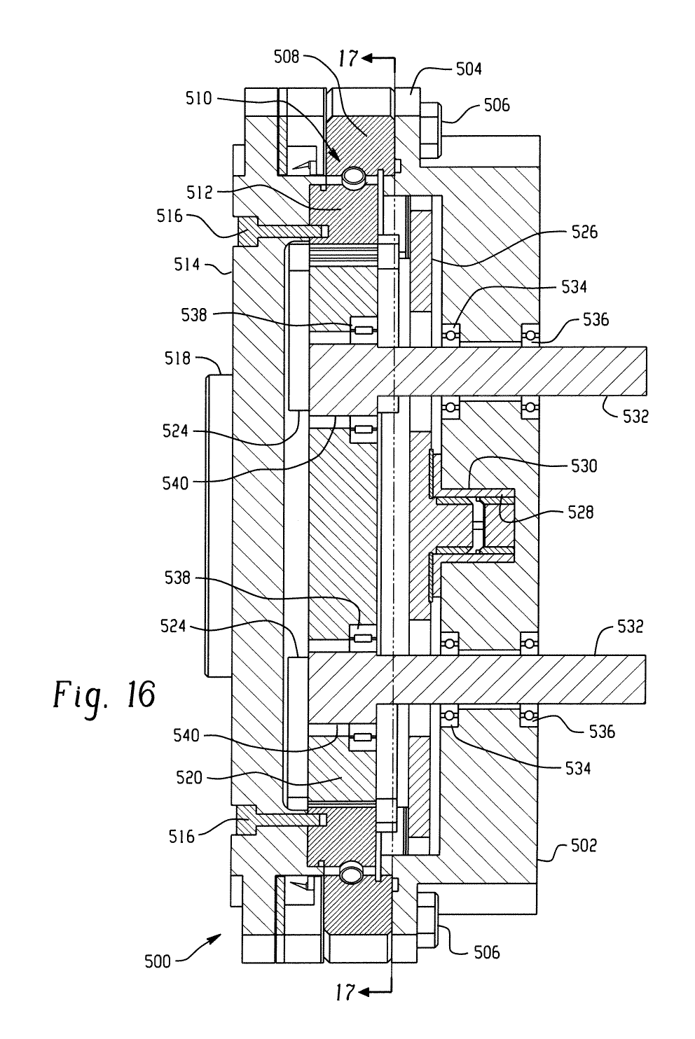

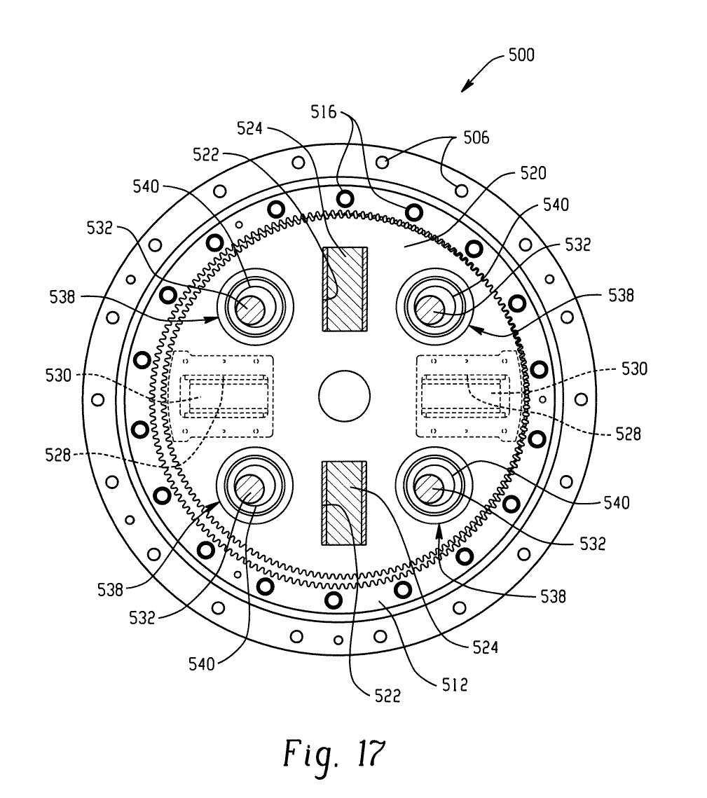

Referring to FIGS. 15, 16 and 17, another version of the speed increaser of the present disclosure is indicated generally at 500 and includes a housing 502 with a radially outwardly extending flange 504 which has attached thereto by suitable fastening means, for example, cap screws 506, an outer bearing race 508 which has journalled on its inner periphery by suitable bearings indicated generally at 510, the outer periphery of an internally toothed ring gear 512. An input member in the form of a circular plate 514 is attached to the ring gear by suitable fasteners such as cap screws 516; and, the input member 514 has a central hub 518 which is adapted for connection to a source of power as, for example, the impeller of a fluid turbine or hydraulic motor.

Disposed within the internally toothed ring gear 512 is an externally toothed spur gear 520 which has a plurality of diametrically opposed slots 522 formed therein into which are received cross guide dogs or lugs 524 extending from a swash plate 526. Similar slots 528 are formed in the housing 502, shown in dashed outline in FIG. 7, into which are received cross guide dogs or lugs 530. The slots 522 in the spur gear 520 are disposed at right angles to the slots 528 in the housing.

The housing 502 has disposed thereabout in spaced arrangement a plurality of output shafts 532, each of which has an end thereof journalled in a pair of bearings 534, 536 and extending outwardly of the housing 502. The opposite end of each shaft 532 has an eccentric 540 formed thereon which is journalled in bearings 538 provided in the spur gear 520. In operation, rotation of the input member 514 and ring gear 512 effects orbiting of the spur gear 520 in a non-rotating manner within ring gear 512 and effects rotary movement of each of the output shafts 532. Thus, the embodiment 500 provides for multiple output shafts driven by a single input shaft utilizing a single non-rotating orbiting spur gear for effecting speed increasing of each of the multiple output shafts 532. The embodiment 500 has particular application for connection to fluid turbine generators such as wind generators in that smaller capacity generators may be driven by each of the output shafts enabling some of the generators to be disabled while others remain operative, such as during high wind conditions.

In the present practice, an exemplary speed increaser and generator according to the present disclosure with a power output of 120 KW has an output shaft with a diameter of about 76 mm, a ring gear pitch diameter of about 482 m, a speed ratio of 80:1 and weighs about 585 lbs (265 Kg), a speed increaser-generator with a power output of about 600 KW has a ring gear pitch diameter of about 122 cm and an output shaft diameter of about 152 mm.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A speed increaser comprising:
a housing having a first end and a second end;
a rotatable input shaft extending through the first end and including a plate mounted on one end;
an internal spur gear mounted on the plate;
an external spur gear which engages the internal spur gear and having a first pair of cross guide slots;
a top plate located at the second end of the housing and having a second pair of cross guide slots;
a cross plate located between the top plate and the external spur gear, the cross plate having a first pair of cross guide projections adapted to be received in the first pair of cross guide slots and a second pair of cross guide projections adapted to be received in the second pair of cross guide slots, both pairs of projections being movable within the slots; and,
a rotatable eccentric shaft extending through the top plate and the cross plate, wherein the spur gear engages the eccentric shaft.

2. The speed increaser of claim 1, wherein the internal spur gear has a diameter greater than the diameter of the output shaft.

3. The speed increaser of claim 1, wherein a first end of the output shaft extends into the one end of the input shaft.

4. A speed increaser comprising:
a geared bearing containing teeth on an internal face;
an inner gear containing teeth on an external face, positioned to contact the teeth of the geared bearing, having a bore, and having a first pair of drive slots therein;
an output shaft eccentrically engaging the inner gear bore and coaxial with the geared bearing;
a swash plate containing a first pair of cross guide projections extending toward the first end of the housing and a second pair of cross guide projections extending toward the second end of the housing;
wherein the first pair of cross drive projections mates with the first pair of slots and the second pair of cross drive projections mates with the second pair of slots.

5. The speed increaser of claim 4, wherein the first pair of cross guide projections and second pair of cross guide projections are substantially perpendicular to each other.

6. The speed increaser of claim 4, further comprising a hub plate to which the geared bearing is attached.

7. The speed increaser of claim 6, further comprising thrust plates located between the swash plate and the inner gear and between the swash plate and top plate.

8. A speed increaser comprising:
a) a housing having a first pair of guide slots;
b) an internally toothed ring gear journalled for rotation on the housing;
c) an input shaft drivingly coupled to the ring gear;
d) an output shaft journalled for rotation on said housing and including an eccentric surface;
e) an externally toothed orbital gear positioned to contact the teeth of the ring gear and having a second pair of slots; and,
f) a swash plate having a first pair of cross guide projections slidingly engaging the first pair of slots and a second pair of cross guide projections slidingly engaging the second pair of slots.

9. The speed increaser defined in claim 8, wherein the first and second pair of cross guide projections are disposed on axially opposite sides of the swash plate.

10. The speed increaser defined in claim 8, wherein the swash plate is formed of titanium material and the first and second pair of cross guide projections have the faces thereof hardened in the range of about 50-55 on the Rockwell “C” scale.

11. The speed increaser defined in claim 10, wherein the first and second pair of cross guide projections have face plates formed of AISI type 440C steel.

12. The speed reducer defined in claim 8, wherein the first and second pair of slots have sliding surfaces formed of material having a pressure-velocity rating of at least 275,000.

13. The speed increaser defined in claim 12, wherein the sliding surfaces are formed of bronze alloy material having a hardness in the range of about 20-24 on the Rockwell “C” scale.

14. The speed increaser defined in claim 8, wherein the housing and swash plate are formed of one of a) titanium and b) aluminum.

15. The speed increaser defined in claim 8, wherein the eccentric surface has an eccentricity determined by the difference in pitch diameter of the teeth on the ring gear and spur gear.

16. The speed increaser defined in claim 8, wherein the spur gear has teeth formed of material having a hardness in the range of about 20-24 on the Rockwell “C” scale.

17. The speed increaser defined in claim 16, wherein the spur gear is formed of SAE 1050 steel.

18. The speed increaser defined in claim 8, wherein said first and second pair of cross guide projections include lubricant passages connected to the sliding surfaces thereof.

19. The speed increaser defined in claim 18, wherein the passages include recesses formed in cover plates attached to the swash plate.

20. The speed increaser defined in claim 18, wherein the lubricant passages include cross passages formed in the cross guide projections.

21. The speed increaser defined in claim 18, further comprising a lubricant supply port in the housing positioned for connecting with the lubricant passages in the cross guide projections.

22. The speed increaser defined in claim 18, further comprising a lubricant face seal between the housing and sliding cross guide projections.

23. The speed increaser defined in claim 18, further comprising a relatively high pressure lubricating system operative to provide an oil film boundary between the slot sliding surfaces and the sliding surfaces of the cross guide projections.

24. The speed increaser defined in claim 8, wherein the ring gear includes a hub plate and the output shaft includes an end thereof journalled for rotation in the hub plate.

25. The speed increaser defined in claim 8, wherein the first and second pair of cross guide projections include removable plates defining sliding wear surfaces.

26. The speed increaser defined in claim 8, further comprising a plurality of output shafts driven by the spur gear.

27. An electric generator having a rotor and stator comprising:
a) a housing having the generator stator thereon and a first pair of slots;
b) an internally toothed ring gear journalled for rotation on the housing;
c) an input member drivingly connected to the ring gear for effecting rotation of the ring gear;
d) an output shaft journalled for rotation on said housing with the generator rotor mounted thereon for rotation therewith, the output shaft having an eccentric surface thereon;
e) an externally toothed orbital gear positioned to contact the teeth of the ring gear and including a second pair of slots, the orbital gear journalled for rotation with respect to said eccentric surface and non-rotating orbiting with respect to the ring gear; and,
f) a swash plate having a first pair of cross guide projections slidingly engaging the first pair of slots and a second pair of cross guide projections slidingly engaging the second pair of slots.

28. The generator defined in claim 27, wherein the input member comprises the hub of a fluid turbine impeller.

29. The generator defined in claim 28, wherein the ring gear has a hub plate and the output shaft is a one piece member having an end journalled in the hub plate.

30. The generator defined in claim 29, wherein the output shaft has an opposite end extending from the housing.

31. The generator defined in claim 29, wherein the output shaft is a hollow tubular member.
